(19) United States
(12) Patent Application Publication
(10) Pub. No.: US 2017/0169526 A1
(43) Pub. Date: Jun. 15, 2017

(54) SYSTEM TO IMPROVE HORIZONTAL CONSTRUCTION

(71) Applicant: ConConn, Inc., Lexington, MA (US)

(72) Inventors: Thomas Joseph Medrek, Windham, NH (US); Paul Bergantino, Lexington, MA (US)

(21) Appl. No.: 15/374,602

(22) Filed: Dec. 9, 2016

Related U.S. Application Data
(60) Provisional application No. 62/266,421, filed on Dec. 11, 2015.

(51) Int. Cl. G06Q 50/08; G06Q 30/06; G06Q 10/06; G06Q 50/18

(52) U.S. Cl. CPC G06Q 50/08; G06Q 50/188; G06Q 30/0635; G06Q 10/06313; G06Q 30/0627

(57) ABSTRACT

Methods, systems, and apparatus, including computer programs encoded on computer storage media. One of the systems includes at least one data store storing listings across a plurality of markets according to a hierarchical, multi-level classification system, the classification system ensuring that users describe listings using consistent terminology, wherein each level in the hierarchy provides additional specificity.

### CLAIM OF PRIORITY

This application claims priority under 35 USC §119(e) to U.S. Patent Application Ser. No. 62/266,421, filed on Dec. 11, 2015, the entire contents of which are hereby incorporated by reference.

### BACKGROUND

Horizontal construction generally refers to the use of machinery such as bulldozers, cranes, graders, dump trucks, and other heavy equipment to move earth and material as part of construction projects. Horizontal construction is a highly fragmented industry made up of a lot of small companies and owner/operators.

### SUMMARY

This specification describes technologies relating to horizontal construction.

In general, one innovative aspect of the subject matter described in this specification can be embodied in a system that includes at least one data store storing listings across a plurality of markets according to a hierarchical, multi-level classification system, the classification system ensuring that users describe listings using consistent terminology, wherein each level in the hierarchy provides additional specificity.

Particular embodiments of the subject matter described in this specification can be implemented so as to realize one or more of the following advantages. Items available can be easily and consistently found. Confusion between buyers and sellers can be reduced. Information can be exchanged between buyers and sellers in real time. Construction equipment may be more efficiently utilized. The time required to schedule and hire horizontal construction vehicles can be reduced.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example of a horizontal construction environment 100.

FIG. 2 illustrates an architecture 200 of a system.

FIG. 3 is a flow chart 300 showing an example negotiation process.

FIG. 4 illustrates an integration between markets.

FIG. 5A-I are examples of a user interface.

FIG. 6 illustrates a user interface displaying managing locations.

FIG. 7 illustrates a user interface that updates search results in real-time.

FIG. 8 illustrates a classification user interface. under Deep Marketplace Classifying a Piece of Heavy Equipment.

FIG. 9 illustrates a user interface for individual looking to buy products and/or services.

FIG. 10 illustrates a user interface for creating an advertisement.

FIG. 11 illustrates a user interface that provides parameterization at Sell Side.

FIG. 12 illustrates a user interface that enables searching based on classification and parameterization.

FIG. 13 illustrates an integrated market place.

Like reference numbers and designations in the various drawings indicate like elements.

### DETAILED DESCRIPTION

Horizontal construction generally refers to the use of machinery such as bulldozers, cranes, graders, dump trucks, and other heavy equipment to move earth and material as part of construction projects. Horizontal construction is a highly fragmented industry made up of a lot of small companies and owner/operators. Large construction projects frequently have a significant horizontal construction component.

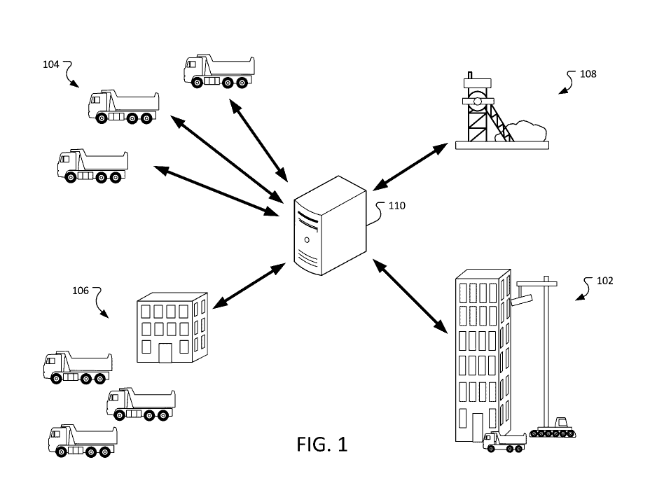

FIG. 1 illustrates an example of a horizontal construction environment 100. Large construction projects 102 generally include a horizontal construction component. For example, the construction company may need to add or remove earth and other materials from the construction site. However, generally, construction companies do not maintain their own fleet of horizontal construction vehicles. (for example, dump trucks) instead the construction company will hire these vehicles on an as-needed basis. Frequently, general contractors, who have overall responsibility for the project, will hire subcontractors to perform excavation or other horizontal construction activities. Even organizations whose primary purpose is the movement of earth (such as a quarry 108 may not maintain their own hauling vehicles.

The vehicles are part of a highly fragmented marketplace made up of owner operators 104, who may each own and operate their own truck, and brokers and trucking companies (represented collectively by the building and vehicles 106) that may manage or own a fleet of vehicles.

Arranging for the needed number of vehicles is further complicated by the fact that construction is subject to delays. For example, if a construction site runs into an unforeseen complication (such as a critical piece of equipment failing or needing repair) the trucks assigned to that construction site may be released (often without compensation), meaning that hauling jobs can be canceled without notice. Accordingly, contractors tend to make plans on a very short time horizon (for example, a typical contractor may determine jobs within a 12 to 48-hour time window).

A system 110 can provide a mechanism whereby owner/operators and suppliers can negotiate and obtain jobs from buyers (such as construction contractors and quarry's). The system can manage the relationship between the suppliers and buyers, providing real-time updates to reflect changing conditions.

In some implementations, the system 110 can treat each vehicle as a separate entity. A company that assigns drivers to particular trucks may provide the identity of the driver to the system 110. In this manner, buyers (such as construction contractors 102 and quarries 108) may be able to select particular drivers that they may or may not want to hire.

As most of the owner/operators spend most of their time in their vehicles, the system may notify the owner operators 104 (or the drivers for the brokers and trucking companies, using push notifications, e-mail, and other communications sent to the driver's mobile device. For example, the system 110 may be coupled to a customized application that executes on the smart phone or other mobile computing device possessed by the driver. At the same time drivers may search available jobs or post their availability on the system 110.

In some implementations, the system 110 may include a software platform that can simultaneously support a variety of online marketplaces that can serve a wide range of markets. It may allow goods and services to be categorized in a flexible yet structured way that allows them to be easily “found” by interested buyers. The system can also track real-time availability and location of the goods and services being sold, as well as the level of demand from the buyer that remains to be booked at every instant in time. Because temporal information can also be tracked, the system can support “micro-advertising” where goods or services can be advertised, searched, and booked for specific windows of time. Once found in search results, buyers can send a booking request to the seller, accepting the seller's list price. Or the buyer can make an offer. For each incoming offer, the seller can accept or reject it, or make counter offer.

In some implementations, the system 110 may support a negotiation process where counteroffers can be exchanged between buyer and seller until agreement is reached or the negotiation is terminated. Once a booking is made, availability of that item or service can be updated in the system and accounted for in any future search results. This way, the system can prevent “double-booking” of items that are for sale, and prevents buyers from overbooking relative to their demand. Services can be searched and booked for any number of days, and cancellations can be made for any combination of days.

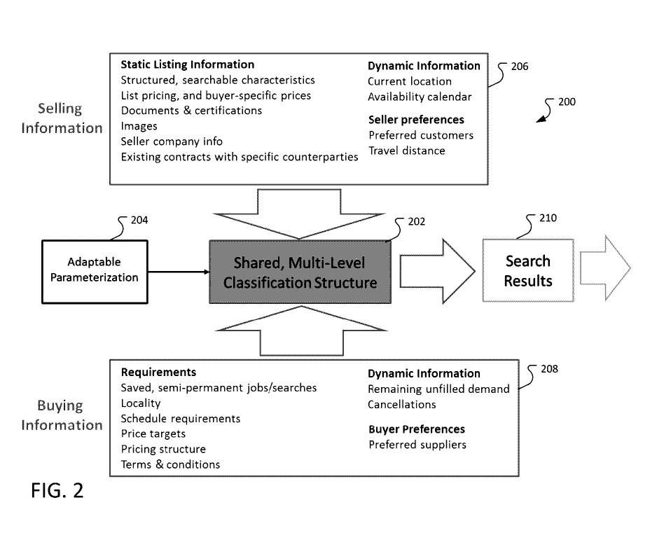

FIG. 2 illustrates an architecture 200 of a system. The system may be, for example, the system 110 described above in FIG. 1.

The architecture includes a shared, multi-level classification structure 202. The classification structure is an editable hierarchy for classifying goods and services for sale in any industry. Each level in the hierarchy delineates all of the sub-categories for each of the categories above. There is no limit to the number of levels that can be supported or the number of categories at each level.

For example, in the horizontal construction industry, where large earth-moving equipment is used, one potential hierarchy includes the following

1. Trucking Services
a. Dump Truck Services
   i. 6-Wheelers
      1. Static structured description: make, model, year, accessories, spill type, acceptable loads, pricing, specific customer contracts including any special pricing, certifications, etc.
      2. Additional dynamic information: location, availability calendar, bookings, and outstanding offers.
   ii. 10-Wheelers
   iii. Tri-axles
   iv. Semitrailer—30 cubic yard capacity
   v. etc.
b. Water Truck Services
c. Snow Plowing
d. etc.

2. General Services
a. Equipment operators
b. Demolition
c. Surveyors
d. etc.

3. Earthen Materials
a. Clean
b. Contaminated
c. etc.

4. Heavy Equipment
a. Cranes
b. Bulldozers
c. Excavators
d. etc.

This multi-level classification structure may be “shared” so that a single structure can be applied across many markets and marketplaces, allowing listings to appear in a familiar way in multiple online marketplaces

The architecture includes adaptable parameterization 204. This is a software tool that defines the multi-level hierarchy above, and allows it to be quickly and easily extended to address new markets, or enhanced to provide more or better levels of classification for existing marketplaces.

Additional seller's information 206 can include static listing information, dynamic information, and seller preferences.

Static listing information can include structured, searchable characteristics, for example information stored in the shared multi-level classification structure 202. The static listing information can also include list pricing and buyer-specific prices. The static list information can also include documents and certifications associated with the seller. The information can also include images (for example, images of the vehicles available) and seller company information. The static listing information can also include information that describes existing contract with specific counterparties (for example, buyers or other suppliers).

Dynamic selling listing information can be provided by sellers for listed items. For many types of markets, it is useful for potential buyers to know the current location of individual items or service person or machine in their search results. It is also useful not to waste time trying to book rental equipment or service people that are already committed to a different buyer on the dates or times that buyers need them.

The system based on this architecture keeps track of this dynamic information for each and every item listed by sellers on the marketplace, so that only items that are available on the desired times & dates and within a specified search radius of the buyer's chosen location are shown in search results

In many businesses, sellers have preferred customers that they give pricing discounts, priority access or some other kinds of preferential treatment to. They may also have preferences as to buyer location or other parameters. These are also built into the structured data for the platform.

The architecture 200 also allows for buyer information to be tracked and stored. Buyer information 208 can include requirements, dynamic information and buyer preferences.

Buyers create named, semi-permanent searches that are saved and can be reused for on-going requirements or a long-running project. These are defined using the same structured data that sellers use above, plus additional information such as when and where particular items or services are needed and for how long, their desired pricing structure (the units that pricing applies to such as per-hour, per unit of weight, per unit of volume, per item). Once a search is performed and the required bookings are completed, that search can be reopened at a later time or date to fulfill additional demand.

Dynamic information can include real-time tracking of unfilled demand. In general, real-time refers to the communication that occurs in less than a second. Some of the items or services that buyers search for may have very limited supply from individual sellers. In those cases, the buyer may need to make offers to multiple sellers to ensure that all of the items that he or she needs can be booked. Using trucking as an example, trucks are often owned by self-employed owner/operators. If a contractor needs 5 of a particular kind of truck at a job site, he may need to make offers to more than 5 truckers to ensure that he gets acceptances for all 5 of the trucks he needs. So not only does the buyer need to know which trucks are actually available when he needs them, but he also needs the marketplace system to guarantee that he doesn't get acceptances for more than the 5 trucks he needs.

Cancellations are another dynamic parameter that is tracked by the system. A cancellation by either buyer or seller has two impacts. It increases the seller's availability by the amount of the cancellation, and it also creates unmet demand for the buyer. The system tracks this information in real-time, allowing both parties to make the necessary adjustments to their business plans.

Buyers can define their own preferences. They can name specific preferred suppliers, and choose preferred types of suppliers.

Once the buyer has created and saved his search parameters, the buyer can perform a search. The system filters the results 210 so that the buyer only sees items or services that meet the structured data requirements, including availability, price, location, and any preferences (for example, the buyer may favor particular sellers or avoid other named sellers). The buyer can define his search to be broad by only requiring results 210 to match 1-2 levels of the structured data hierarchy, or can be very fine-grained by including additional levels of hierarchy and/or additional structured data in the search requirements.

Results can be filtered and sorted in a variety of ways.

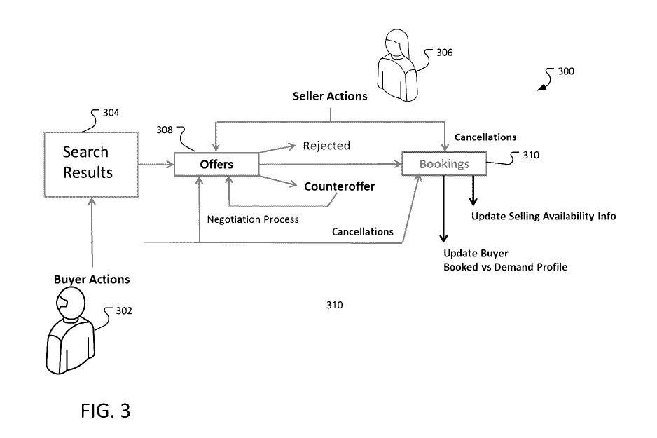

FIG. 3 is a flow chart 300 showing an example negotiation process. Once the buyer identifies a listing based on the search results 304, the Buyer 302 start the process by making an offer 308 to the seller 306 of a listed item or service. The offer 308 can simply match the seller's terms, or the buyer 302 can try to negotiate by offering terms that are different from the seller's standard terms. The seller 306 can then view the offer 308 and accept it, reject it, or make a counter-offer. Each side can continue the send counter-offers until a both sides agree and a booking 310 is made or until one side decides to reject the most recent counter-offer. In some cases, non-traditional terms may be included or barter may be made instead of a monetary sale. Those cases are covered by online chat that is archived as part of the purchase record.

Once a booking 310 is made, the sellers' 306 availability calendar for that item or service is updated as appropriate. This is particularly important for rental equipment and services. The buyer's 302 bookings for that search are also re-mapped against its demand profile, so that information on any unmet demand for it is kept current and is available to the buyer 302.

Buyers 302 and sellers 306 both have the freedom to cancel all or part of an order. If that happens the counterparty receives an instant notification by their choice of text, instant message, and/or email. Seller's availability calendar and the buyers unmet demand profile are also updated as above.

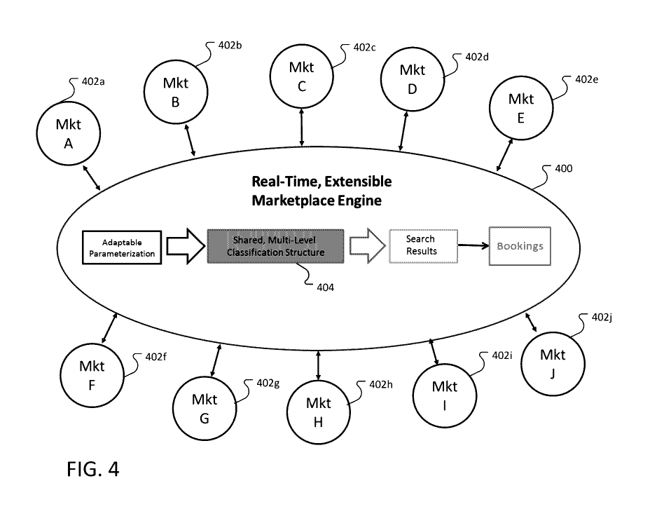

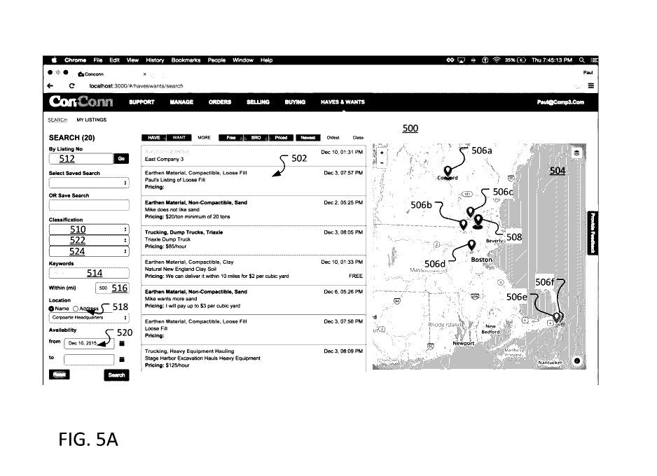

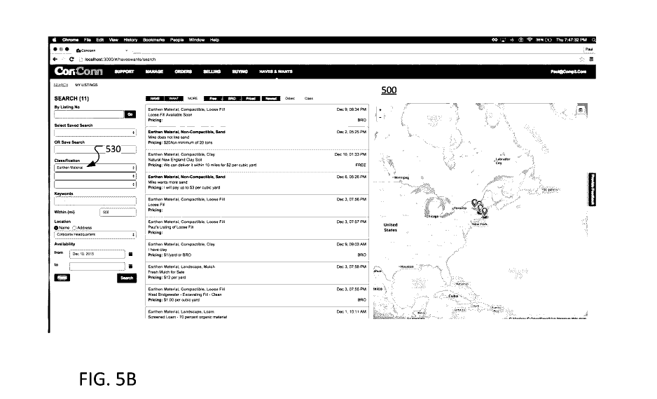

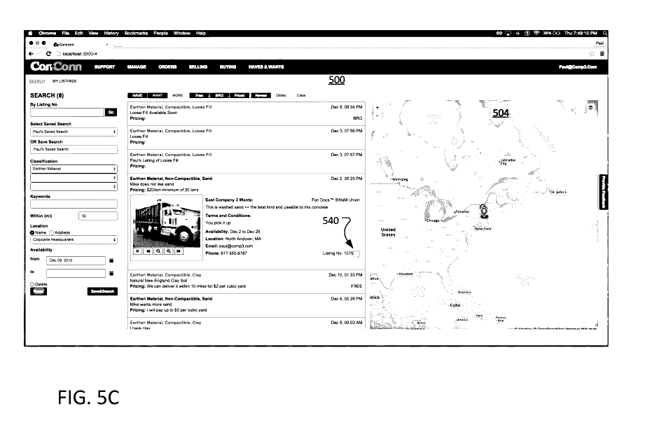

FIG. 4 illustrates an integration between markets. The Real-Time, Extensible Marketplace Engine 400 can be used to provide an integrated family of distinct online marketplaces (for example Mrt A-J 402a-j) each serving separate but related markets or applications. These markets may have overlapping user communities, but all under a single umbrella to provide a unified user experience. The Shared, Multi-Level Classification Structure 404 is the heart of this unified system, and it is enhanced by a common searching/booking process that takes into account items' geographic location and availability on a very fine-grained, per-unit basis.

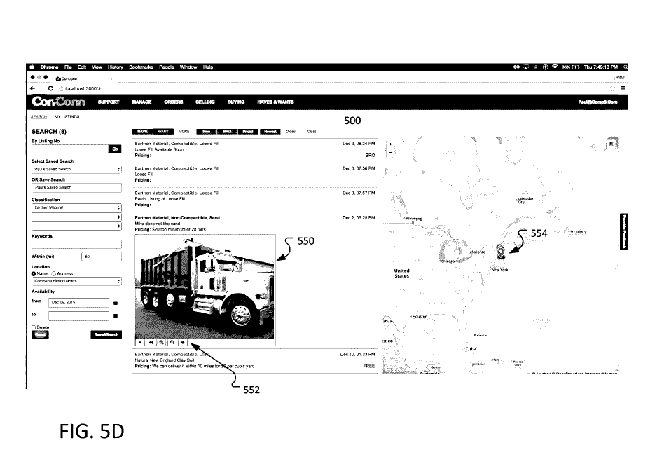

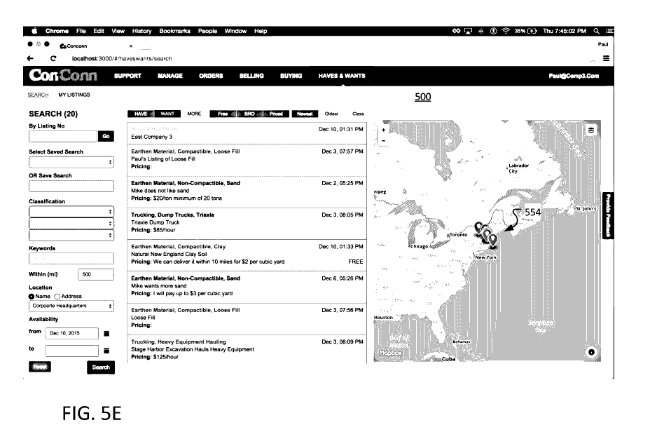

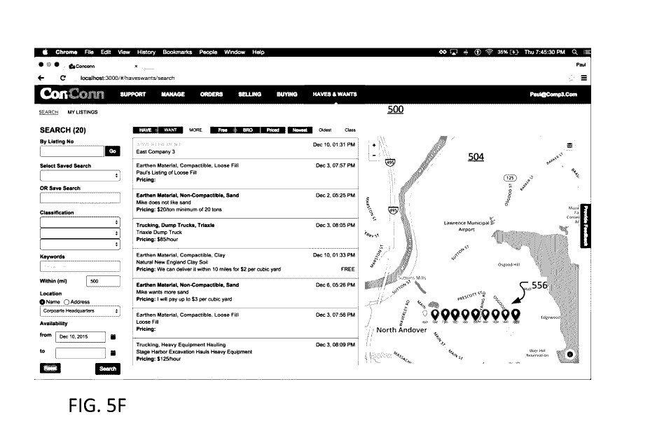

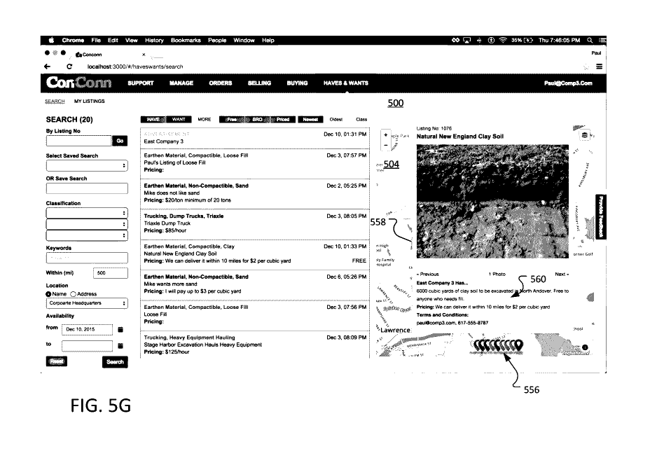

FIG. 5A is an example user interface 500 illustrating an overview of Haves and Wants, a industry specific implementation of an online classified advertising system that has, heretofore, lacked such capability. The user interface 500 can enable a user to search and display listings according to their classification structure. In this example, the user interface 500 enables the user to specify three levels of the classification structure (searchable using the classification drop downs a first drop down 510 for Class A, a second drop down 522 for Class B, and a third drop down 524 for Class C). In this example, Class A is the most general classification in the hierarchy, Class B is in the middle, and Class C is the most specific classification in the hierarchy. In some implementations, the hierarchy may include more levels or fewer levels. The search feature may enable users to search and display a particular portion of the classification hierarchy. For example, items may be classified based on a higher level class that is selected automatically based on the user interface 500 being viewed. For illustration purposes, one classification may include

1. Horizontal Construction
a. Earthen Material
   i. Compactable
      1. Loose Fill

In this example, the top level of the hierarchy (i.e. Horizontal Construction) is selected based on the page being viewed. The system allows for items to be searched and discovered based on at multiple different levels of the hierarchy. For example, a user may search based on Class A (which would include all records having the same value in Class A regardless as to contents of Class B and Class C). The user may search based on Class A and Class B (which would include all records having the same value in the Class A and Class B regardless of the contents of Class C) and so on.

In some implementations, reflecting the hierarchical nature of the classification system, the contents of the third drop down 524 depends on the selected value of the second drop down 522 and the contents of the second drop down 522 depends on the contents of the first drop down 510.

This system is powerful in (one way) that it allows a listing to be applied at any level of the hierarchy system, thus incorporating advertising and listings in a single user interface.

At the higher levels of abstraction an ad takes on a brand/product category nature (for example, an Earthen Materials ad that did not specify Class B or Class C would be advertising the participation of the advertiser in the Earthen Materials business generally—more so than advertising, for example, a most specific items that specified Class B and Class C (such as the excess byproduct of a specific foundation dig, etc.))

The user interface 500 also integrates different listing types (Have, Want, Pure Advertisement). The user interface 500 can use color coding with Haves, Wants and Advertisements using different colors based on listing type. The colors used in the listing are consistent with the colors or the corresponding markers (for example, the Have markers 506a-f and the Want marker 508) on the map 504. The markers on the map 504 can be made to reflect the values in the different levels classification or ad type. For instance, a gravel listing could have a market that wants rocks or provides rocks within the boundary of the marker. The system can also uses shading to indicate the specified level of the hierarchy that matches the search within a marketplace type (Have, Want, and Advertisement). In this example, a darker shade represents a more abstract listing (a listing that specifies only the higher levels of the hierarchy (such as Class A). A Class A listed item (that does not specify Class B or Class C) is darkest (could be lightest in a different design choice). an advertisement for Trucking/Heavy Equipment Hauling that specifies Class A and Class B is shown darker than the classified listings that specify all three levels of classification (Class A, Class B, and Class C).

The marketplace is strongly classified based on this hierarchy to enable a workable system where users know where to list and find all different categories of goods, products, assets and services. The system can also enforce specification of location of all goods, products, services, and advertisements.

The user interface 500 enables the user to specify a maximum distance and a time frame (for example, within 5 miles from Jan. 5th to Jan. 10^{th}). These characteristics are central to the horizontal construction industry that is characterized by high costs associated with movement, and thus is better served by a unique marketplace design as described above. The classification is applied to different aspects of the user interface including the deep (BUY SELL) and opportunistic-dynamic (HAVES & WANTS) aspects of the marketplace. The classification enforces a consistency that generates a positive user experience due to the consistent and rational nature of the design.

The user interface 500 enables users to search using the classification, for example, using the drop down lists 510. The user interface 500 also selects searching based on listing number 512, key words 514, distance 516, location 518, and availability 520.

FIG. 5B illustrates how the system's predefined classification system can be used to limit a search to just a single class and all of its subclasses. Listings can be defined at any of the three levels of hierarchy including Class A—Earthen Materials 530 in this example; Class B—Compactible, Non Compactible, Landscape in this example (sub classes under Earthen Materials); and Class C—Loose Fill, Sand, Clay, Mulch in this example (sub classes under their respective Class B classes's). This example shows a search at the top (Class A) level that selects all sub classes of the Class A class (Earthen Materials in this example).

If the select under Earthen Materials in the search bar (the Class B selection) were opened it would reveal a number of Class B classes including the ones shown in the diagram (Compactible, Non Compactible, Landscape). Selecting one of these would limit the search to only those listings matching at Class A and Class B—but including all Class C of the selected Class A/Class B combo. Selecting Class B as Compactible would limit the results, in the example above, to Loose Fill and Clay listings.

Map Markers match the results in number and color (etc). As described above with respect to FIG. 5A, the system also includes location and radius of opportunity, window of opportunity (Availability From/To), keyword searches, and proximity searches all of which represent important considerations in horizontal construction.

FIG. 5C. illustrates a user interface 500 with listings that expand in-place and provide information and a chat window. The user interface 500 enables chat 540 between parties from within the system and maintains the chat as a permanent record of the transaction. The system also allows negotiation with chat using structured data including Price, Units, Quantity Available, Quantity desired. This level of structure for an opportunistic marketplace is unique—and it is consistent with a unique system design that treats its marketplaces as an integral part of the project management and record keeping spaces. The level of structure exits in our deep marketplace as well.

FIG. 5D illustrates a user interface 500 that allows for expansion of an image 550, and scrolling through the images, in place (for example, using the controls 552). This is designed to facilitate image sharing and to increase the speed of analyze the listings applicability. When a user elects to increase the size of the image 550, some fields have may be temporarily removed to make way for the listing's images. The system allows quick view of the multiple listings via summary classification, title and pricing date and very fast in depth exploration and communication with the counterparty as demonstrated in this and its predecessor slide.

Map markers 554 can be used to locate listings and advertisements on the page. Most system suffer marker collisions, making it a slow and cumbersome process to explore the representative data when multiple markers are in close proximity. The system again leverages the unique nature of the horizontal construction industry where locality is important but absolute locality is sometime neither critical nor desirous to be shared (with potential competitors). For example, if one is looking for excess fill, it is not too important whether it is 1 mile east, west, north or south—or 2 miles for that matter. What matters is that it is “close by”. The system can leverage this fact to, when desired, decimate the GPS coordinates of listings such that the listings line up in a straight line (or array or other useful non-location specific alignment). This makes it easy to cycle through multiple listings quickly without having to necessarily expand and move the map to get behind collocated (exact or close) markers and markers in congestion. The user interface 500 takes all of the markers in an area and, when beneficial, can line them up. The markers don't necessarily fall in their absolute positions, but they are close enough to convey the costs associated with locality—and they are far easier to explore. The user interface can also indicate the nature of the listing in the color of the marker. Colors use include, but are not limited to, Blue for Wants, Salmon for Haves, Yellow for Advertisements. This decimation and alignment is a highly productive way to explore listings on a map. The extensive search classification capability that also filters markers (since it filters the associated listings) can be manipulated to insure that the lined-up markets represent listed (various) that are of interest. Since all markers represent (various) listings of interest, all markers need be explored and the line-up makes this fast.

FIG. 5E illustrates a user interface 500 with a distant map view: Typical view from afar. Markers block one another (note that want and advertisement markers may be hidden behind the majority of the have markers. In some implementations, markers may be displayed based on the type of user. For example, the map for a buyer may place have markers in front of want markers, the map for a seller may place the want markers in front of the have markers.

FIG. 5F illustrates a user interface 500 with a closer map 504 view. As a user zooms in, the user interface reorganizes markers 556 that are closely placed into a line. Alignment of the markers may be accomplished by any several means including collecting listings in an arbitrary or calculated (from the listings own GPS and radius of opportunity calculations) fashion and lining them up. There is a loss locational accuracy. Based on the listing type this is often either preferred (security) or not detrimental Lining up and collocating listing types allows for the following efficient exploration of meaningfully similarly located (various). As the user zooms out, the markers 556 may be returned to their original position (for example, based on geographic location).

FIG. 5G-H illustrates obtaining more information about a location from the map 504. When the user selects on of the map markers 556, an information window 558 may be displayed. The information window 558 may include information 560 about the listing associated with the selected map marker. In some implementations, the information 560 displayed in the information window 558 may be taken from the corresponding listing.

FIG. 5I illustrates that the user interface 500 may include an ability to put an item on a watch list and to obtain quick access to watched items and alerts when activity occurs around these and/or similar listed. The structured classification of the system and location and radius of interest classification of searches allows the system to send notification of when new listings are posted that match a user's saved search.

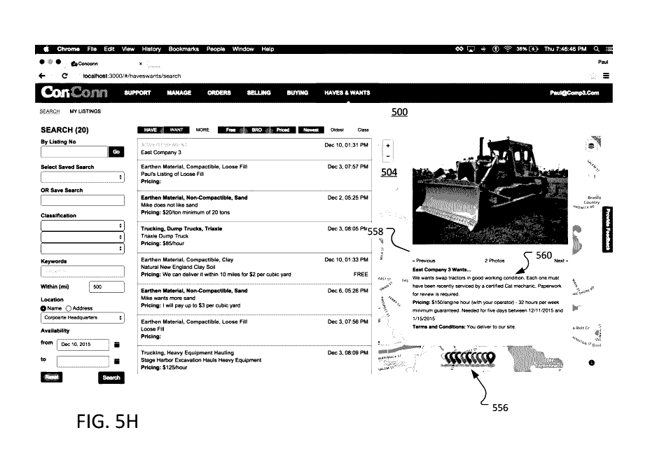

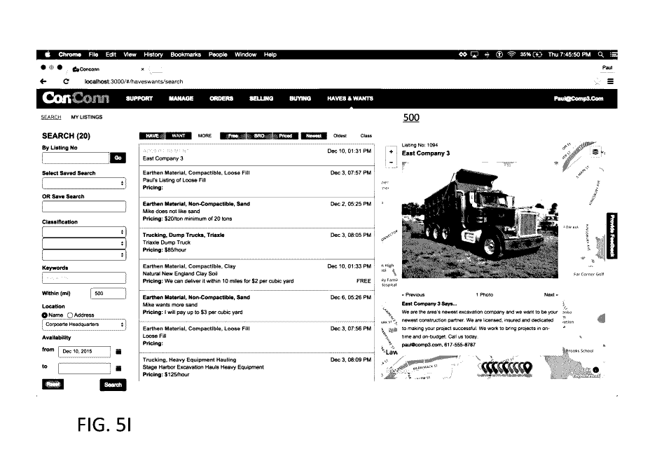

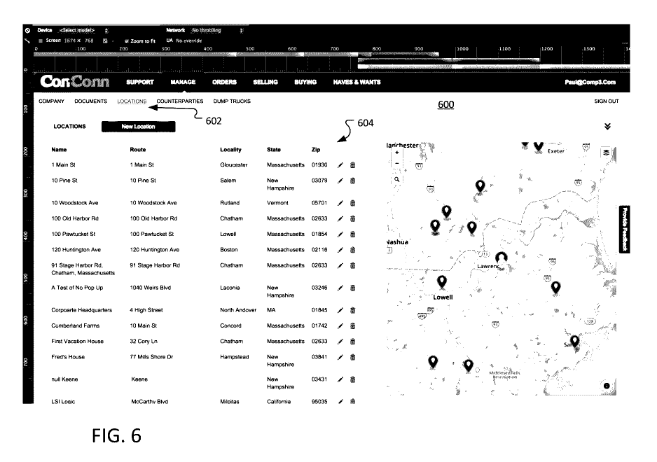

FIG. 6 illustrates a user interface 600 displaying managing locations. The system is highly structure. Locations can be managed as an integral part of a user and/or a listing. It is so important to the horizontal construction industry—and other to be claimed markets—that an entire section 602 of the user interface 600 can be dedicated to establishing and managing locations. The remainder of the marketplace allows for location association via pull-down menu selection from these saved and managed locations. The central location management feature makes operations within the system extremely fast as location data 604 need not be captured, corrected (for address and spelling) and geo-located for each operation within the system. Address data tends to be static and sticky—it is relevant for an extended period of time—and thus a system that facilitates building a database of address of interest—and then allows for quick application of those addresses time and time again—in all planes of the system—is a highly productive and useful system. In general, the system may use the address of the user as the home base for an equipment provided by the user. This enables the system to fairly and accurately account for travel time and pay when the situation warrants. Further, users have incentives to provide accurate information about their basis of operations as the users which to sell and/or buy locally.

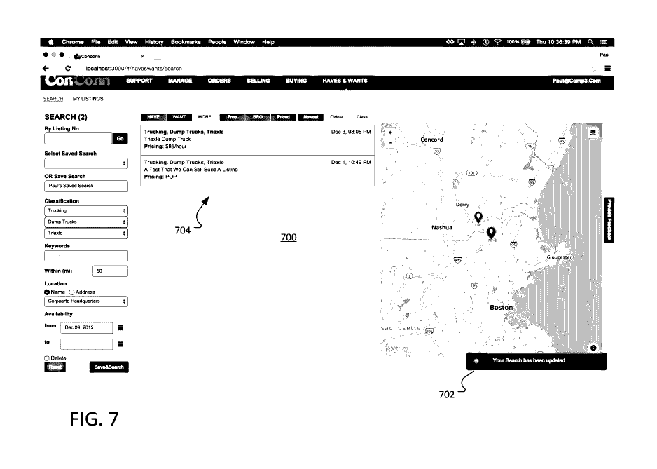

FIG. 7 illustrates a user interface 700 that updates search results 704 in real-time. In this example, the user is notified of a change to search results though a pop-up message 702.

In some implementations, the classification may include information about a listing that is not searchable. For example, the Machine Size, Insured, Colors, Attachments components of the classification system are treated not as searchable classes but as parameters associated with the classified object. The parameters help one quantify the description on the sell side and the same parameters are used on the buy side to inform and filter search results. These parameters need not be extended into Haves and Wants—making the Haves and Want that much faster of a system to use. This example shows Machine Size, Insured By, Colors and Attachments as parameters.

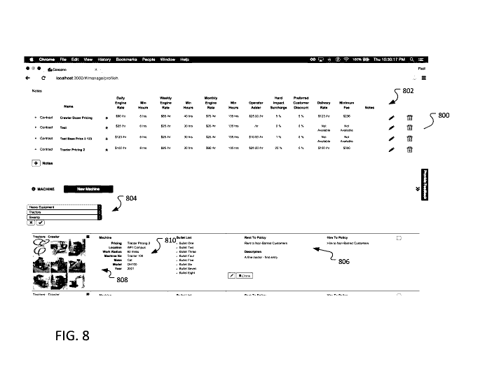

FIG. 8 illustrates a classification user interface 800. under Deep Marketplace Classifying a Piece of Heavy Equipment. The classification user interface 800 includes a list of contracts 802 associated with the selected equipment 808 (in this example a Tractor: Crawler). Each contract in the list 802 identifies different available contracts, pricing, weekly rate, minimum number of hours/week, monthly rate, minimum hours/month, operator adder, a hard impact surcharge (for example, for work that adds abnormal wear and tear on the machinery), a preferred customer discount, a delivery rate, and a minimum fee, etc.

The machine is classified using the classification selector 804. In this example, the classification system uses the same three tier system as described above (Class A, Class B, and Class C). In this example, the machine has been classified under Class A as heavy equipment, under Class B as Tractors, and under Class C as Swamp.

The user interface 800 also included additional information 810 about the machine, for example, the location of the machine, a work radius, the make, model, and year of the machine, as well as a machine number. As described above, in some implementations, the location of the equipment is automatically set based on the location of the contractor who owns the machine. This has the ability to smooth negotiations when determining travel costs.

Other information on the user interface also includes policy information 806. The policies are determined by the contractor or owner of the machine. For example, whether the machine is available for rent (for example, without an operator), a description of the machine, and a whether the machine is available for hire (for example, with an operator).

In this example, the policy information 806 indicates that the machine is available to rent or hire to non-barred customers. The system may provide a mechanism whereby a user may bar particular customers (indicating that they are not interested in doing business with them.)

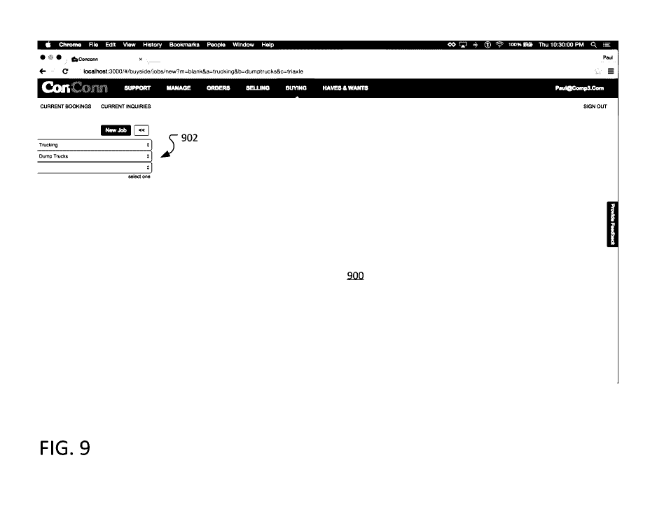

FIG. 9 illustrates a user interface 900 for individual looking to buy products and/or services. The user interface 900 allow the user to specify their interest using the same classification system by filling in the classification drop down 902.

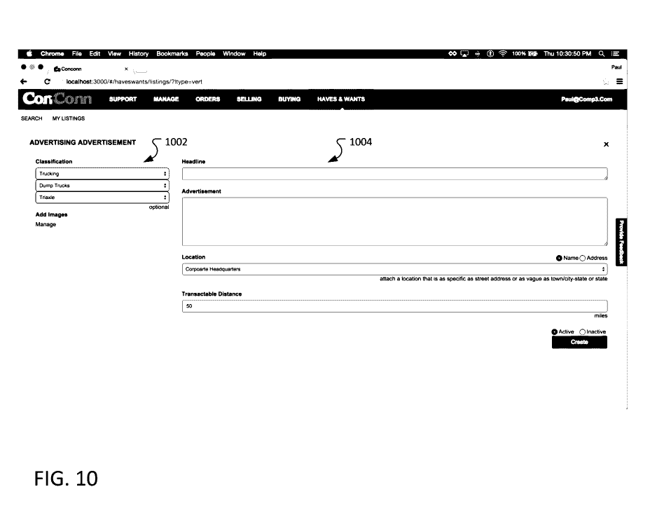

FIG. 10 illustrates a user interface 1000 for creating an advertisement. In this example, the user is advertising tri-axle dump truck services. The advertisement is classified using the same classification system (in this example, Class A, Class B and Class C) as is used throughout the market place. The classification system makes the advertisement easy to find for interested parties systemic and universal nature of the classification system.

The user can also specify addition information 1004 about the advertisement. For example, the user can provide a headline, the advertisement body, a location to associate with the advertisement, and a maximum transaction distance.

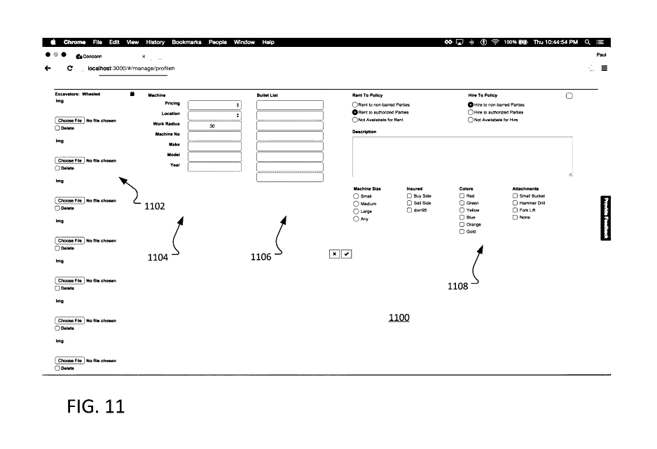

FIG. 11 illustrates a user interface 1100 that provides parameterization at Sell Side. The user interface 1100 used on the sell side to classify the item for sale. The user interface 1100 is used in reverse on the buy side as a series of filters to locate available items. This unique and structured design allows the system to scale quickly and rationally. In this example, the user interface 1100 is being used on the sell side, to define a particular machine available for sale. The user is able to provide images of the machine using the first column 1102 of the user interface 1100. Information about the machine can be provided in the second column 1104. A bullet list can be defined in the third column 1106. Policy information can be defined in the fourth column 1108.

In some implementations, the Machine Size, Insured, Colors, Attachments components of the classification system are treated not as searchable classes but as parameterizing the classified object. The parameters help one quantify the description on the sell side and the same parameters are used on the buy side to inform and filter search results. These parameters need not be extended into Haves and Wants—making the Haves and Want that much faster of a system to use. This example shows Machine Size, Insured By, Colors and Attachments as parameters

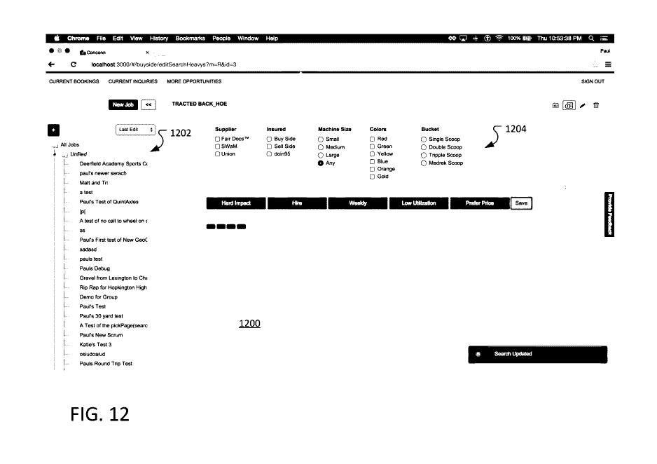

FIG. 12 illustrates a user interface 1200 that enables searching based on classification and parameterization. The left hand side 1202 of the user interface show different items that are available to purchase. The details on the right hand side of the user interface 1200 enables the user to filter the list of jobs based on different parameterization 1204.

The user interface 1200 also illustrates how this marketplace behaves like a hybrid job management/accounting system. All searches are saved and can be brought back up quickly. This filing system for searches is unique and highly productive as searches are often repeated and a single search may require multiple days of searching and negotiating.

The same user classification system can be used in both contexts. It uses a scripting language to define the characteristics, and a rendering engine that renders the classification filters on the fly on both the buy side and the sell side interfaces.

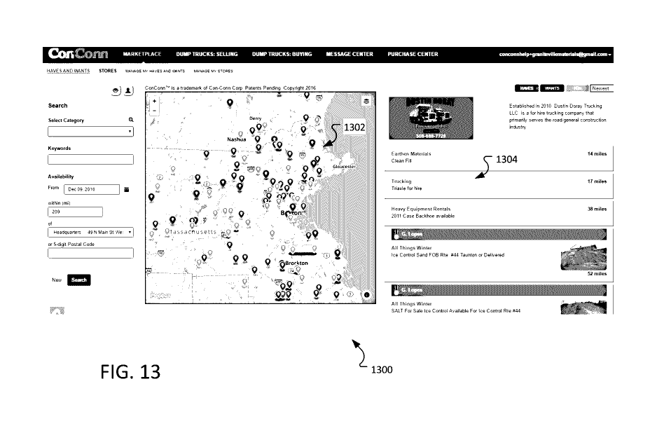

FIG. 13 illustrates a user interface 1300 showing an integrated market place. The user interface 1300 displays results on the right 1304 related to a search query. The results contain an integration of listings from different market places (for example, Have and Wants, and Stores). The listings are all displayed on a map 1302. The map markers can be color coded based on the market from which the listing originated.

In summary, the system provides a unique collection of marketplaces within different heuristics that when combined form a remarkably coherent platform/marketplace. The system enables the management of captive resources in a private island within a public marketplace that allows excess private assets to be offered for sale or for rent into the public marketplace when desired in a seemless fashion.

The system provides a combination of a software platform that can simultaneously support a variety of dynamic online marketplaces that can serve a wide range of markets. The software platform a software platform that can simultaneously support a variety of goods and dynamic dispatched services in these marketplaces. The software platform can coherently organize and simultaneously display a series of marketplaces that are different in nature but coherent in collection (for example, a classified advertising (“Haves and Wants”) marketplace for serendipitous/short duration transactions, a deep supply “Stores” marketplace for deliberate/deep supply/in-the-business-of transactions, a cooperative dynamic-activity marketplace that views listings and transactions across all of the individual marketplaces and identifies business opportunities that can be created by connecting them together.

For example, a contractor advertising excess common fill from a job site in the Haves and Wants marketplace can be cross referenced with a supplier taking in and selling common fill in the Stores marketplace and can be either connected with or advertised to truckers that may be passing by both the excavation site and store.

Additionally, to the above, the system can include a sophisticated purchasing and dispatch system used, in one implementation, for finding, negotiating with suppliers, hiring in and directing dump truck runs. The purchasing and dispatch system can manage the resources (dump trucks) required to facilitate many of the transactions in these marketplaces. It can also be used to hire dump trucks for activities that do not include transactions within the marketplaces.

Conventional marketplaces do not control truck dispatching. Marketplaces often allow request of shipping and shipping options, but they do not allow the selection of specific shippers, negotiation of rates, or communication with shippers and drivers to effect transactions arranged through the marketplace or for stand-alone hire. This system allows and facilitates the selection of specific shippers, negotiation of rates, and communication with shippers and drivers to both facilitate transaction within the marketplace and for standalone hire. Its inclusion is critical to deliver a platform that organizes buying, selling, controlling, advertising within at least the example industry (horizontal construction) under a single platform and to realize the meaningful benefits of doing so.

A sophisticated purchasing and dispatch system that can be used to manage captive resources (for example, dump trucks) in a private mode within an otherwise public marketplace. One benefit provided by the system is the ability to make captive assets available for rent as public supply when they are deemed excess for a period of time either through formula (for example, if not booked internally by 2:00 release them to the marketplace) or manually (“at most I will need two of the five remaining trucks—let me release (promote to the public marketplace) three of them now while waiting to see on the other two)”.

An extensible platform that allows a set of industry specific applications to be embedded in a coherent and cross-functional fashion.

A software system construction that, in effect, embeds the greater marketplace/platform allowing management to access real-time information on purchase costs, utilization of hired assets, billing status, etc. The cohesive and coherent organization results in a system that delivers unparalleled productivity in finding goods and services that match buyers' requirements and are available, and then purchase them using in-application Requests for Quote by buyers, formal Price Quotations by sellers preparation, and Purchase orders. Management can also assess utilization of assets and services acquired in the marketplace.

The systems can interact to allow multiple activities to be organized within a single platform focused on an industry.

In some implementations, a hierarchical, multi-level classification system which ensures that buyers and sellers use the same wording to describe specific types of listings is used to improve the ability of a user to find a desired listing. The multi-level classification system can allow searches by buyers to be very broad or specific depending on how many levels of classification they choose to use for their search.

The classification system can be extensible allowing users can enter, update and modify both static and dynamic content in real time, thereby having up-to-date inventory and service availability presented and transactable by buyers.

The multi-level classification system can be augmented by static and dynamic structured data that adds significantly more detail about each listing. The structured data can be searchable by other users. For example, static data structured can include information about product and service descriptions, and dynamic structured data can include schedule and availability, and potentially real-time location tracking information such as by GPS or tracking cell phone location. The hierarchy and structured data is extensible so that a single structure can be applied across many markets and marketplaces.

Adaptable Parameterization defines the multi-level hierarchy above, and allows it to be quickly and easily extended to address new markets, or enhanced to provide more or better levels of classification for existing marketplaces.

Trucking of availability and current location of specific service items (such as trucks or rental equipment) can be used to ensure that only relevant items appear in search results. (For example, if the truck is located outside the effective range of the search, the truck will not appear.)

In some implementations, when multiple of an item or service is needed by a buyer, the system can continuously track how much demand from the buyer remains unmet. The system can automatically withdraw all outstanding purchase offers when demand is met, and thus prevents over-booking by buyers or double-booking by sellers.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs (i.e., one or more modules of computer program instructions, encoded on computer storage mediums for execution by, or to control the operation of, data processing apparatus). A computer storage medium can be, or be included in, a computer-readable storage device, a computer-readable storage substrate, a random or serial access memory array or device, or a combination of one or more of them. The computer storage medium can also be, or be included in, one or more separate physical components or media (e.g., multiple CDs, disks, or other storage devices). The computer storage medium can be non-transitory.

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example, a programmable processor, a computer, a system on a chip, or multiple ones, or combinations, of the foregoing. The apparatus can include special purpose logic circuitry (e.g., an FPGA (field programmable gate array) or an ASIC (application-specific integrated circuit)). The apparatus can also include, in addition to hardware, code that creates an execution environment for the computer program in question (e.g., code that constitutes processor firmware, a protocol stack, a database management system, an operating system, a cross-platform runtime environment, a virtual machine, or a combination of one or more of them). The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural or object-oriented or functional languages, and it can be deployed in any form, including as a stand-alone program or as a module, component, subroutine, service, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry (e.g., an FPGA (field programmable gate array) or an ASIC (application-specific integrated circuit)).

Processors suitable for the execution of a computer program include, by way of example, both general and special purpose microprocessors, and any one or more processors of any kind of digital, analog or quantum computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive, data from or transfer data to, or both, one or more mass storage devices for storing data (e.g., electronic, magnetic, magneto-optical disks, or optical disks), however, a computer need not have such devices. Moreover, a computer can be embedded in another device (e.g., a mobile telephone, a personal digital assistant (PDA), a mobile audio or video player, a game console, a GPS receiver, or a portable storage device (e.g., a universal serial bus (USB) flash drive)), to name just a few. Devices suitable for storing computer program instructions and data include all forms of non-volatile memory, media and memory devices, including by way of example semiconductor memory devices (e.g., EPROM, EEPROM, and flash memory devices), magnetic disks (e.g., internal hard disks or removable disks), magneto-optical disks, and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback) and input from the user can be received in any form, including acoustic, speech, or tactile input. In addition, a computer can interact with a user by sending documents to and receiving documents from a device that is used by the user (for example, by sending web pages to a web browser on a user's user device in response to requests received from the web browser).

Embodiments of the subject matter described in this specification can be implemented in a computing system that includes a back-end component (e.g., as a data server), a middleware component (e.g., an application server), or a front-end component (e.g., a user computer having a graphical user interface or a Web browser through which a user can interact with an implementation of the subject matter described in this specification), or any combination of one or more such back-end, middleware, or front-end components. The components of the system can be interconnected by any form or medium of digital or optical data communication (e.g., a communication network). Examples of communication networks include a local area network (“LAN”) and a wide area network (“WAN”), an inter-network (e.g., the Internet), and peer-to-peer networks (e.g., ad hoc peer-to-peer networks).

The computing system can include users and servers. A user and server are generally remote from each other and typically interact through a communication network. The relationship of user and server arises by virtue of computer programs running on the respective computers and having a user-server relationship to each other. In some embodiments, a server transmits data (e.g., an HTML page) to a user device (e.g., for purposes of displaying data to and receiving user input from a user interacting with the user device). Data generated at the user device (e.g., a result of the user interaction) can be received from the user device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can, in some cases, be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A software platform that simultaneously supports a variety of dynamic online marketplaces that serves a wide range of markets and simultaneously support a variety of goods and dynamic dispatched services in these marketplaces.

2. A system comprising a software platform that coherently organizes and displays a series of marketplaces that are different in nature but coherent in collection, the software platform including the ability to view and match-make between opportunities and transactions across each of these marketplaces.

2. The system of claim 2 wherein the market places includes a classified advertising “Haves and Wants” marketplace for serendipitous/short duration transactions, a deep supply “Stores” marketplace for deliberate/deep supply/in-the-business-of transactions, and a dynamic marketplace for the provisioning of services such as dump truck services for horizontal construction.

3. The system of claim 2, further comprising a purchasing and dispatch system used configured to enable a user to find and negotiate with suppliers, hire in and direct dump truck runs.

4. The system of claim 3, wherein the purchasing and dispatch system manages resources required to facilitate many of the transactions in these marketplaces.

5. The system of claim 3, wherein the sophisticated purchasing and dispatch system that can be used to manage captive resources in a private mode within an otherwise public marketplace.

6. The system of claim 2, further comprising an extensible platform that enables a set of industry specific applications to be embedded in a coherent and cross-functional fashion.

7. The system of claim 2, further comprising a software system construction that embeds the greater marketplace/platform within an ERP/MRP platform and enables access of real-time information of at least one of purchase costs, utilization of hired assets, and billing status.

8. The system of claim 2, further comprising a hierarchical, multi-level classification system which ensures that buyers and sellers use the same wording to describe specific types of listings, and enables searches by buyers to be very broad or specific depending on how many levels of classification they choose to use for their search.

9. The system of claim 8, wherein the multi-level classification system is augmented by static and dynamic structured data.
